(19) United States
(12) Patent Application Publication
(10) Pub. No.: US 2015/0009151 A1
(43) Pub. Date: Jan. 8, 2015

(54) TOUCH KEYBOARD

(71) Applicant: YOMORE TECHNOLOGY CO., LTD., Kaohsiung City (TW)

(72) Inventors: JAO-CHING LIN, Taipei (TW); Chun-Kai NI, Taipei (TW); Wen-Ting LEE, Taipei (TW)

(21) Appl. No.: 14/324,138

(22) Filed: Jul. 4, 2014

(30) Foreign Application Priority Data
Jul. 4, 2013 (TW) 102212696

(51) Int. Cl. G06F 3/02; G06F 3/041

(52) U.S. Cl. CPC G06F 3/0202; G06F 3/041
USPC 345/168

(57) ABSTRACT

A touch keyboard includes a main touch keyboard and an auxiliary touch keyboard. The main touch keyboard includes a main touch sensing element and a main processor. The main touch sensing element is provided for touching to generate a user touching signal. The main processor electrically connected with the main touch sensing element and is provided for receiving user touching signal and switching the keyboard type which is indicated by the main touch sensing element. The auxiliary touch keyboard can detachable connected to the main touch keyboard. The auxiliary touch keyboard includes an auxiliary touch sensing element that is electrically connected with and is controlled by the main processor. The detachable main touch keyboard and the auxiliary touch keyboard are switched to other keyboard type by the main processor and the switched keyboard is provided for variety application to achieve the multifunctional intelligent keyboard.

### FIELD OF THE INVENTION

The present invention relates to a touch keyboard, in particular to multiple function touch keyboard with variety keyboard types.

### BACKGROUND

In recently, with the rapid development of touch sensing technology, more and more electronic devices begin using the main touch sensing element to replace the traditional input methods, and thus touch keyboard also emerged. The touch keyboard in many cases replacing the traditional physical keyboard, not only bring convenience for the people, but also to provide a more beautiful and comfortable working environment.

However, a number of commonly used touch keyboard installed rechargeable battery or external power plug to supply the power required manner, which is very inconvenient for using. In addition, the function of the touch keyboard merely exchanges with that of the physical keyboard, which is the text input function, such that the function of the touch keyboard seems relatively simple, and the touch keyboard cannot provide a number of applications for the user.

Thus, if there is a touch keyboard can generate the power by itself and did not rely on the computer, and beside the text input function, the touch keyboard can also provide the more convenient and multiple operations for the user.

### SOME EXEMPLARY EMBODIMENTS

According to above drawbacks in the conventional prior art, the present invention provides a touch keyboard, in particular to a multiple function touch keyboard includes a switch keyboard type and wireless transmission.

According to one embodiment of the present invention, a touch keyboard is applied for a host computer, which includes a main touch keyboard and at least one auxiliary touch keyboard. The main touch keyboard is electrically connected with the host computer, which includes at least one main touch sensing element and a main processor. The main touch sensing element is provided for touching to generate a user touching signal. The auxiliary touch keyboard is detachable connected to the main touch keyboard. The auxiliary touch keyboard includes a auxiliary touch sensing element and is electrically connected the main processor and is controlled by the main processor. In addition, the auxiliary touch keyboard also includes an auxiliary processor such that when the auxiliary touch keyboard can work independently when the auxiliary touch keyboard is not electrically connected to the main touch keyboard. The user touching signal is received by the main touch sensing element and the auxiliary touch sensing element can transmit the user touching signal to the main processor such that the main processor can receive the user touching signal. The main processor can switch the keyboard type of the auxiliary touch sensing element according to the user touching signal.

Accordingly, to compare the traditional touch keyboard, the keyboard can divide into a detachable main touch keyboard and an auxiliary touch keyboard in the present invention, and the keyboard types of the touch keyboard can switch by the main processor for variety of applications. Thus, not only more convenience using for user, but also the multi-functional intelligent keyboard can be achieved.

### BRIEF DESCRIPTION OF THE DRAWINGS

The disclosure is illustrated by way of example, and not by way of limitation, in the figures of the accompanying drawings in which like reference numerals refer to similar elements and in which:

FIG. 1 shows a schematic view of a touch keyboard in accordance with the present invention disclosed herein;

FIG. 2 shows an exploded view of a main touch keyboard of the touch keyboard in accordance with the present invention disclosed herein;

FIG. 3 shows a flow process of the mode switching method of the touch keyboard in accordance with the present invention disclosed herein;

FIG. 4 is a schematic view of one embodiment of the auxiliary touch keyboard in accordance with the present invention disclosed herein;

FIG. 5 is a schematic view of one embodiment of the auxiliary touch keyboard in accordance with the present invention disclosed herein;

FIG. 6 is a schematic view of one embodiment of the auxiliary touch keyboard in accordance with the present invention disclosed herein;

FIG. 7 is a schematic view of one embodiment of the auxiliary touch keyboard in accordance with the present invention disclosed herein;

FIG. 8 is a schematic view of one embodiment of the auxiliary touch keyboard in accordance with the present invention disclosed herein; and

FIG. 9 is a schematic view of one embodiment of the auxiliary touch keyboard in accordance with the present invention disclosed herein.

### DESCRIPTION OF THE PREFERRED EMBODIMENT

The embodiments of the apparatus and/or methods are disclosed. In the following description, for purposes of explanation, numerous specific details are set forth in order to provide a thorough understanding of the embodiments of the invention. It is apparent, however, to one skilled in the art that the present invention may be practiced without these specific details or with an equivalent arrangement.

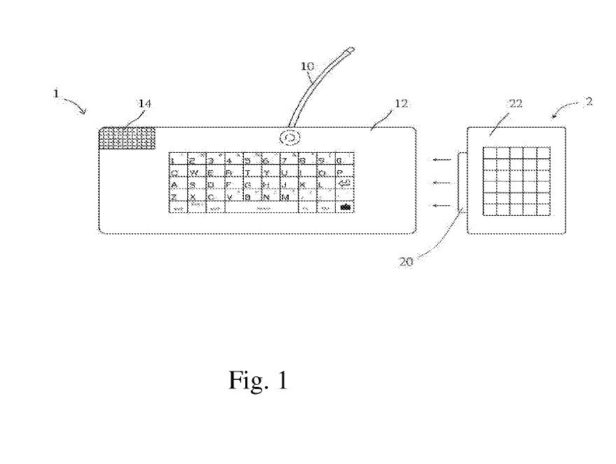

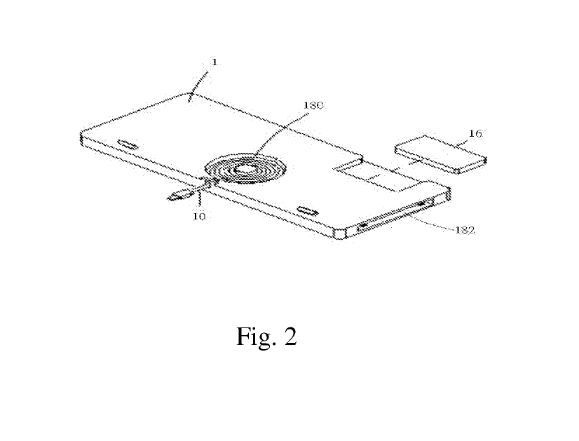

Please refer to FIG. 1 and FIG. 2. FIG. 1 is a schematic view of a touch keyboard of the present invention. FIG. 2 is an exploded view of main touch keyboard of the touch keyboard. As shown in FIG. 1 and FIG. 2, the touch keyboard of the present invention is applied for a host computer or a household appliance. The touch keyboard includes a main touch keyboard 1 and an auxiliary touch keyboard 2.

The main touch keyboard 1 is electrically connected to the host computer via a data line 10. The main touch keyboard 1 includes at least a main touch sensing element 12 and a main processor 11. The main touch keyboard 1 also includes a solar plate 14, a rechargeable battery 16, a storage tank 180 and a recess 182. The data line 10 is universal serial bus (USB). In general, when the touch keyboard 1 is electrically connected to the host computer through the data line 10, the signal is transmitted between the touch keyboard 1 and the host computer through the data line 10, and the data line 10 can also transmit the output electric power from the host computer to the main touch keyboard 1 for providing the required electric power of the main touch keyboard 1 for operation.

The main touch sensing element 12 can be a touch panel and is disposed on a top surface of the main touch keyboard. The main touch sensing element 12 is provided with an interactive platform for touching so as to generate a user touching signal. When the user touches the main touch sensing element 12 by the finger or touch pen, the main touch sensing element 12 will generate the user touching signal according to the location where is touched by the finger or touch pen.

The main processor 11 includes at least one memory that is electrically connected with the main touch sensing element 12, and receives the user touching signal form the main touch sensing element 12. The memory includes a data bank and the data bank includes a plurality of touching gestures and a plurality of pressed icons which are corresponding to the reference data of the plurality of keyboard types respectively. When the main processor 11 receives the user touching signal, the main processor compares the touching gesture or the pressed icons which is indicated by the user touching signal with the data bank of the memory so as to calculate and switch the keyboard type corresponding to the main touch sensing element 12.

For example, when the main processor 11 receives the user touching signal from the main touch sensing element 12, the main processor 11 will determine whether the user touching signal indicates the keyboard types as displayed for the user wants to switch the main touch sensing elements 12. After confirmation, the keyboard type is displayed by the main touch sensing element 12 that is switched according to the user touching signal. In addition, the main touch sensing element 12 displays the keyboard type which is a main keyboard type.

The solar plate 14 is disposed on the top surface of the main touch keyboard 1 for receiving the sunlight to generate an electronic signal. The rechargeable battery 16 can dispose on the bottom surface of the main touch keyboard corresponding to the top surface of that, and is electrically connected with the main touch sensing element 12 and the solar plate 14 for receiving and storing the solar plate 14 to generate the electronic signal. The rechargeable battery 16 provides the required electronic power for the touch keyboard.

The storage unit 180 is an annular pattern which is disposed on the bottom surface of the main touch keyboard 1 for receiving the data line 10. When the main touch keyboard 1 is not electrically with the host computer by using data line 10, the data line 10 can be received in the storage unit 180. When the touch keyboard is electrically connected with the host computer through the data line 10, the user can draw out the data line 10 from the storage unit 180 for connecting the touch keyboard with the host computer. This not only saves the storage space is also convenient for the user to carry.

The recess 182 is disposed on one side of the main touch keyboard which opposites the top surface and the bottom surface of that. The recess 182 includes at least one connection terminal. Each connection terminals is electrically connected with the main processor 11 or the rechargeable battery 16.

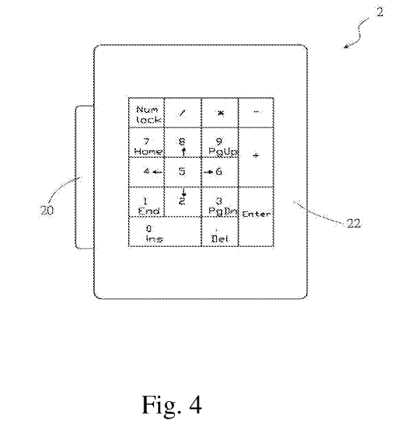

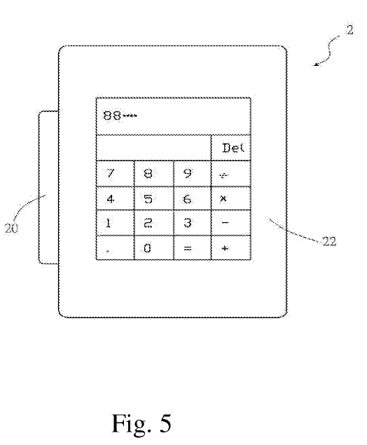

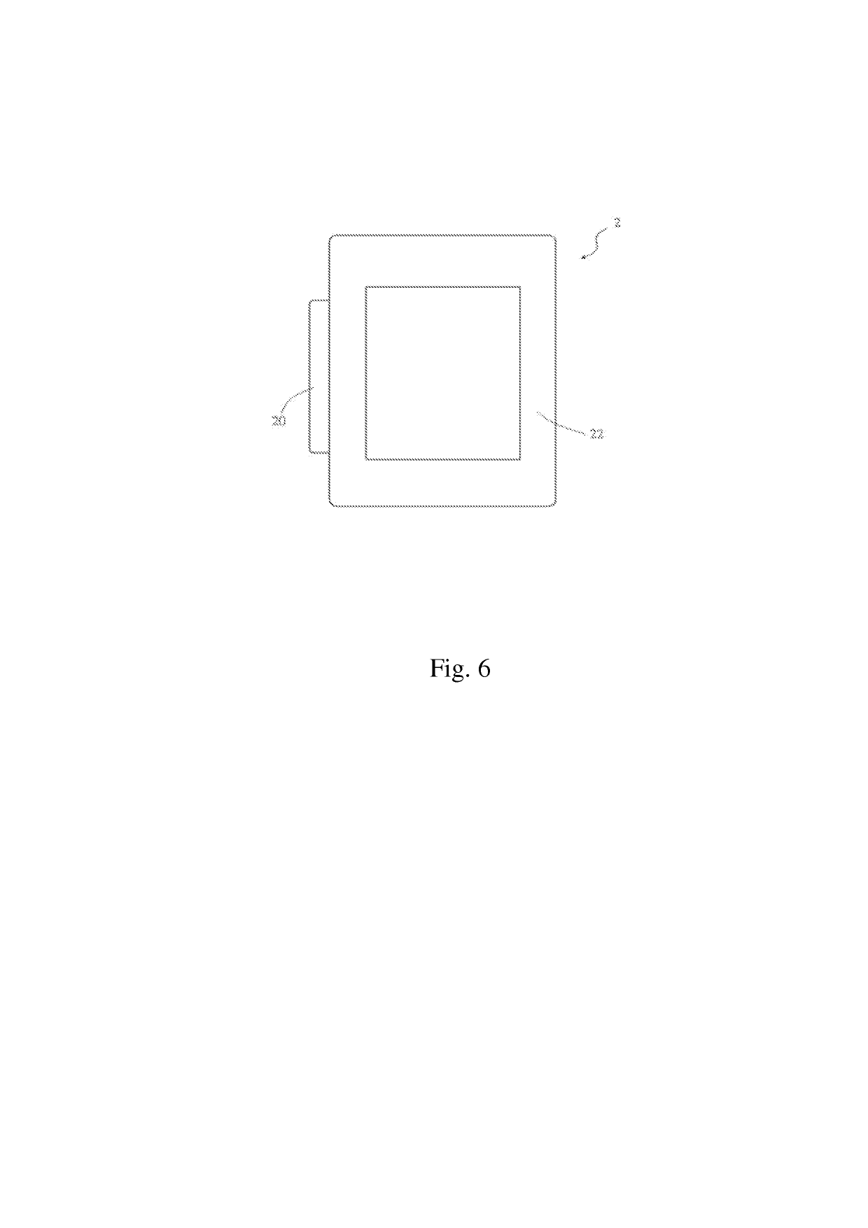

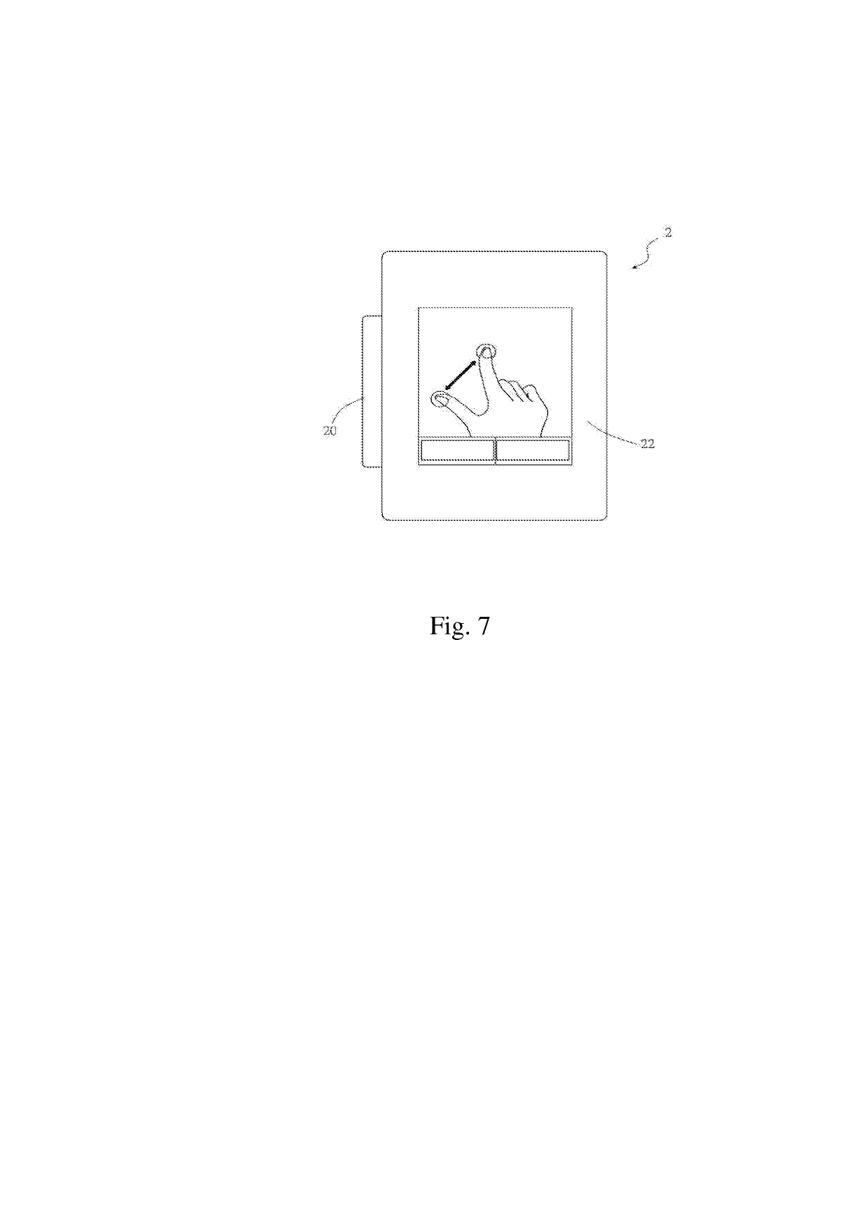

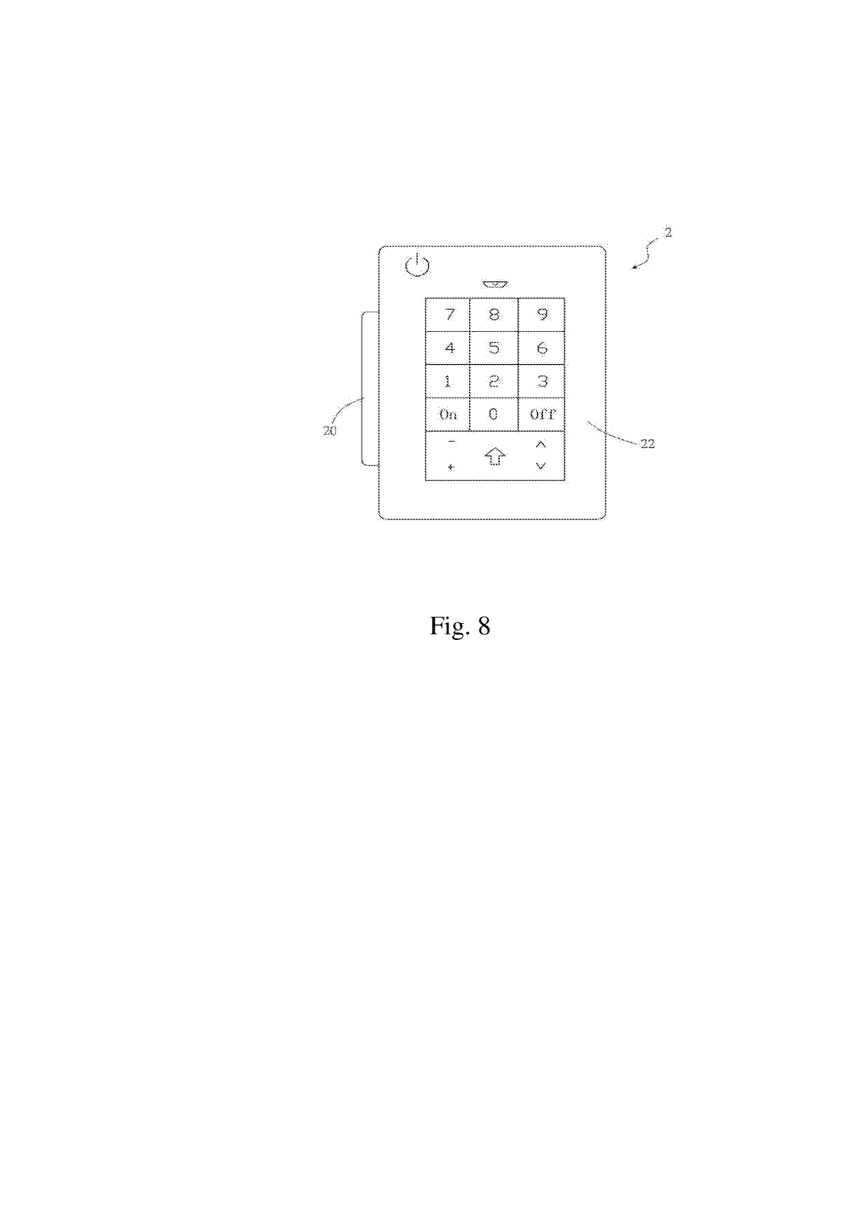

Please refer to FIG. 1 and FIG. 4 to FIG. 8. FIG. 4 is a schematic view of an auxiliary touch keyboard. FIG. 5 is a schematic view of an auxiliary touch keyboard. FIG. 6 is a schematic view of an auxiliary touch keyboard. FIG. 7 is a schematic view of an auxiliary touch keyboard. FIG. 8 is a schematic view of an auxiliary touch keyboard.

As shown in figures, the auxiliary touch keyboard 2 is electrically connected with the main touch keyboard 1. A protrusion portion 20 is disposed on one side of the auxiliary touch keyboard 2. The auxiliary touch keyboard 2 is magnetic attracted or embedded detachable by using protrusion portion 20 to the recess 182 of the main touch keyboard 1. The protrusion portion 20 further includes at least a transmission terminal. Each transmission terminals is corresponding to each connection terminals. The auxiliary touch keyboard 2 is electrically connected with each connection terminal via the each transmission terminal. The auxiliary touch keyboard 2 can receive the required electric power or transmit the data from the main touch keyboard via each the connection terminal.

The auxiliary touch keyboard 2 includes at least an auxiliary touch sensing element 22, an auxiliary processor 21 and a wireless transmission device (not shown). The auxiliary touch sensing element 22 is disposed on one surface of the auxiliary touch keyboard 2. The auxiliary touch sensing element 22 is provided an interactive platform for touching so as to generate the user touching signal. When the auxiliary touch keyboard 2 is electrically connected with the main touch keyboard 1 and is electrically connected with the main processor 11 via the transmission terminal, the user touching signal is output to the main processor 11. The main processor 11 compares the touch gestures represented by the user touching signal or pressed icon with the data bank in the memory to calculate and switch the keyboard types which is represented by the auxiliary touch sensing element 22.

For example, when the auxiliary touch keyboard 2 is electrically connected with the main touch keyboard and user clicks the icon or slides the screen through the main touch sensing element 12 or the auxiliary touch sensing element 22 to switch the keyboard type as an auxiliary keyboard type. The main processor 11 will instruct the auxiliary touch sensing element 22 to switch the keyboard type as an auxiliary keyboard type (as shown in FIG. 4). When the user clicks the icon or slides the screen through the main touch sensing element 12 or through the auxiliary touch sensing element 22 to switch the keyboard type as a calculating machine type, the main processor 11 will instruct the auxiliary touch sensing element 22 to switch the keyboard type as a calculating machine type (as shown in FIG. 5).

When the user clicks icon or slides the screen through the main touch sensing element 12 or the auxiliary touch sensing element 22 to switch the keyboard type as a handwriting plate, the main processor 11 will instruct the auxiliary touch sensing element 22 to switch the keyboard type as a handwriting plate (as shown in FIG. 6). When the user clicks the icon or slides the screen through the main touch sensing element 12 or the auxiliary touch sensing element 22 to switch the keyboard type as a touching mouse type, the main processor 11 will instruct the auxiliary touch sensing element 22 to switch the keyboard type as a touching mouse type (as shown in FIG. 7). When the user clicks the icon or slides the screen through the main touch sensing element 12 or through the auxiliary touch sensing element 22 to switch the keyboard type as a remoter type, the main processor 11 will instruct the auxiliary touch sensing element 22 to switch the keyboard type as a remoter type (as shown in FIG. 8).

The auxiliary processor 21 includes at least a memory which is electrically connected with the auxiliary touch sensing element 22. The memory of the auxiliary processor 21 stores a data bank. The data bank includes a plurality of touching gestures and a plurality of icons corresponding to the reference values of the plurality of keyboard types respectively. When the auxiliary processor 21 receives the user touching signal through the auxiliary touch sensing element 22, the auxiliary processor 21 will compare the touching gesture or the pressed icon with the data bank in the memory to calculate and switch the keyboard types corresponding to the auxiliary touch sensing element 22, in which the pressed icon indicates the user touching signal.

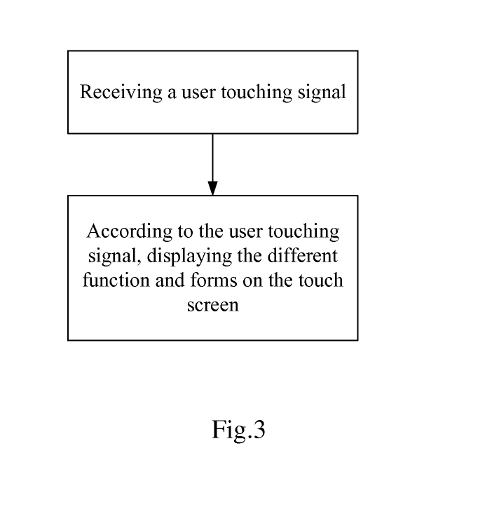

Please refer to FIG. 3. FIG. 3 is a flow process of the mode switching method for the touch keyboard. The mode switching method utilizes an auxiliary touch sensing element 22 as a touch screen, and receives a user touching signal in step S30 and step 32 denotes that according to the user touching signal, the keyboard types corresponding to the different functions or forms which is displayed on the touch screen to switch the keyboard type which is displayed by the auxiliary touch sensing element 22.

For example, when the auxiliary processor 21 receives the user touching signal from the auxiliary touch sensing element 22, the auxiliary processor 21 will determine that the user touching signal is indicated the keyboard type which is displayed according to the user wants to switch the auxiliary touch sensing element 22. After confirmation, the keyboard type is displayed by switching the auxiliary touch sensing element 22 corresponding to the information which is indicated by the user touching signal.

When the auxiliary touch keyboard 2 is electrically connected with the main touch keyboard 1, the auxiliary touch sensing element 22 can switch the keyboard types which displayed according to the instruction of the main processor 11. When the auxiliary touch keyboard 2 is not electrically connected with the main touch keyboard for independently operation, the auxiliary touch sensing element 22 will switch the keyboard types according to the instruction o the auxiliary processor 21.

Accordingly, when the auxiliary touch keyboard 2 is not electrically connected with the main touch keyboard 1, user clicks icon or slides the screen through the auxiliary touch sensing element 22 to switch the keyboard type as an auxiliary keyboard types, the auxiliary processor 21 will instruct the auxiliary touch sensing element 22 to switch the keyboard type as an auxiliary keyboard type (as shown in FIG. 4). When the user clicks icon or slides the screen through the auxiliary touch sensing element 22 to switch the keyboard type as a calculating machine type, the auxiliary processor 21 will instruct the auxiliary touch sensing element 22 to switch the keyboard type as a calculating machine type (as shown in FIG. 5). When the user clicks icon or slides the screen through the auxiliary touch sensing element 22 to switch the keyboard type as a handwriting plate, the auxiliary processor 21 will instruct the auxiliary touch sensing element 22 to switch the keyboard type is handwriting plate (as shown in FIG .6). When the user clicks icon or slides the screen through the auxiliary touch sensing element 22 to switch the keyboard type as a touching mouse type, the auxiliary processor 21 will instruct the auxiliary touch sensing element 22 to switch the displayed keyboard type as a touching mouse type (as shown in FIG. 7). When the user clicks icon or slides the screen through the auxiliary touch sensing element 22 to switch the keyboard type as a remoter type, the auxiliary processor 21 will instruct the auxiliary touching sensing element 22 to switch the displayed keyboard type as a remoter type (as shown in FIG. 8).

The wireless transmission device is electrically connected with the auxiliary processor 21, and the wireless transmission device transmits the signal by the way of the wireless network or Bluetooth. When the auxiliary touch keyboard 2 is not electrically connected with the main touch keyboard 1, the auxiliary processor 21 of the auxiliary touch keyboard 2 is electrically connected with the host computer or household appliances and data transmission therebetween by the way of wireless transmission device. For example, for the auxiliary touch keyboard 2 is not electrically connected with the main touch keyboard 1, the user switch the auxiliary touch sensing element 22 to display the keyboard type as a remoter type, and by the auxiliary touch keyboard 2, the user can remote-control the host computer or household appliances through the wireless network or Bluetooth by the remoter type.

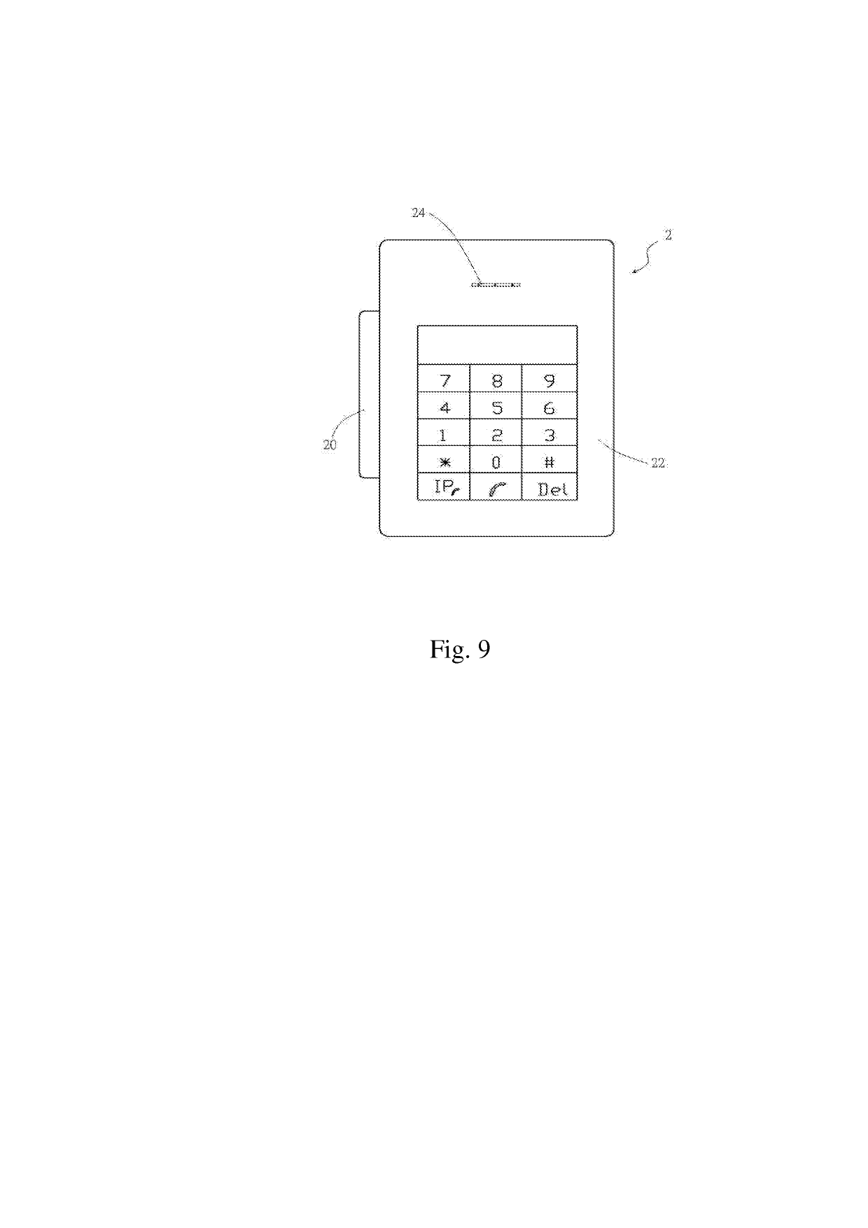

Please refer to FIG. 9. FIG. 9 is a schematic view of an auxiliary touch keyboard of the touch keyboard of the present invention. In this embodiment, the mode switch method can switch the keyboard type of the touch keyboard to the auxiliary call machine. Thus, the auxiliary touch keyboard 2 further includes a telephone transmitter 24 and the auxiliary processor 21 further includes a voice package process unit or is to be electrically connected with an auxiliary package processor. The telephone transmitter 24 includes a headphone and a microphone, which are electrically connected with the auxiliary processor 21 and is provided for receiving an audio to generate a voice signal by the auxiliary processor 21. The auxiliary processor 21 transmits the voice signal to the host computer through the wireless transmission device and is cooperated with the voice software such as Skype or QQ which is installed in the host computer to transmit to a remote calling. Then, the auxiliary processor 21 will receive the voice signal from the voice software through the host computer by the way of the wireless transmission device. Then, the auxiliary processor 21 will instruct the telephone transmitter 24 to voice a sound according to the voice signal, such that the user can hear the information which is indicated by the voice signal. Thus, the auxiliary touch keyboard 2 is able to perform the remote calling.

Thus, comparing with the traditional touch keyboard, the keyboard of the present invention is a detachable main touch keyboard and an auxiliary touch keyboard, and the main processor 11 or the auxiliary processor 21 of the touch keyboard switches the displayed keyboard type of the variety touch keyboard according to the mode switching method for the variety application. It not only easy operation for the user, but also the multi-functional intelligent keyboard can be achieved.

While the invention has been described in connection with a number of embodiments and implementations, the invention is not so limited but covers various obvious modifications and equivalent arrangements, which fall within the purview of the appended claims. Although features of the invention are expressed in certain combination among the claims, it is contemplated that these features can be arranged in any combination and order.

What is claim is:

1. A touch keyboard, comprising:
a main touch keyboard is connected a host computer, comprises:
at least a main touch sensing element is provided for touching to generate a user touch signal; and
a main processor is electrically connected with said main touch sensing element; and
at least a auxiliary touch keyboard is detachable connected to said main touch keyboard, said auxiliary touch keyboard having an auxiliary touch sensing element which is electrically connected with said main processor and is provided for touching to generate a user touching signal;
wherein said main processor is provided for receiving said user touching signal and a keyboard type of said auxiliary touch sensing element is to be switched according to said user touching signal.

2. The touch keyboard according to claim 1, wherein said main touch keyboard further comprising:
a solar plate is provided for receiving the sunlight to generate an electronic signal; and
rechargeable battery is electrically connected with said solar plate to receive and store said electronic signal to provide a required electric power for said main touch keyboard.

3. The touch keyboard according to claim 1, wherein said main touch keyboard having a storage unit which is disposed on a bottom surface of said main touch keyboard and is provided for storing a data line therein.

4. The touch keyboard according to claim 1, wherein said auxiliary touch keyboard is embedded in said main touch keyboard and is provided for receiving a required electric power form said main touch keyboard.

5. The touch keyboard according to claim 1, wherein said auxiliary touch keyboard is connected to said main touch keyboard via the magnetic attraction, and is provided for receiving a required electric power from said main touch keyboard.

6. The touch keyboard according to claim 1, wherein said auxiliary touch keyboard is electrically connected with said host computer or an electronic device via said wireless transmission device, said auxiliary touch keyboard further comprising:
an auxiliary processor is electrically connected with said auxiliary touch sensing element which is provided for receiving said user touching signal and switching said keyboard type of the said auxiliary touch sensing element according to said user touching signal; and
a wireless transmission device is electrically connected with said auxiliary processor which is provided for connecting with said host computer or an electronic device.

7. The touch keyboard according to claim 6, wherein said auxiliary touch keyboard further comprising a telephone transmitter which is electrically said auxiliary processor.

8. The touch keyboard according to claim 1, wherein said keyboard type includes an auxiliary keyboard, a calculating machine, a handwriting plate, a touching mouse, a remoter or a voice call machine.
